(19) United States
(12) Patent Application Publication
(10) Pub. No.: US 2010/0174902 A1
(43) Pub. Date: Jul. 8, 2010

(54) PORTABLE STORAGE MEDIA WITH HIGH SECURITY FUNCTION

(75) Inventor: Chih-Ling Wang, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: PHISON ELECTRONICS CORP., Chutung Town (TW)

(21) Appl. No.: 11/306,338

(22) Filed: Dec. 23, 2005

(51) Int. Cl. H04L 29/06

(52) U.S. Cl. 713/165

(57) ABSTRACT

A portable storage media with high security function is disclosed. The portable storage media comprises a microprocessor, a sensor and a memory. The microprocessor is connected to a data transmission interface, a sensor transmission interface and a memory transmission interface, wherein the data transmission interface is adopted for connecting to a host end. The sensor is connected to the sensor transmission interface of said microprocessor, wherein said sensor is adopted for inputting a biological feature. The memory is connected to the memory transmission interface of the microprocessor. The biological features are used as the passwords for accessing the protected data or files stored in the portable storage media. An encrypting program is adopted for encrypting/decrypting the data or files to prevent any hackers from stealing the data or files from the portable storage media.

### BACKGROUND OF INVENTION

1. Field of Invention

The present invention generally relates to a portable storage media with high security function, and more particularly to a portable storage media, employing the user's biological feature as a password, comprising a encrypting program to protect the data or files stored therein.

2. Description of Related Art

Rapid development of the computer information in the 20^{th} century has paved a way to a great revolution of mankind. People use computers almost all the time and everywhere, and important information or files are stored or used in the computers. Generally speaking, passwords are set to protect the important information or files stored in the storage device. However, the continuous improvement in the technology, hackers have the ability to hack into the information make the password unreliable. Even without cracking the passwords, the hackers use the special tools to directly retrieve the protected information or files from the storage device. Besides, the protection of important information using password can be really a problem if the user forgets it.

The latest computer is designed to be more powerful, faster speed and smaller in size. Accordingly, the number of communication ports and memory storage devices, for example, hard disk or CD-ROM, of the computer for connecting to peripheral devices are being reduced. One approach would be to use a hub to connect to external hardware to achieve the goal of reducing the number of communication ports. Thus, the use of memory card, portable ROM and external hard disk are popular and allow the user to save information into memory card via computer or PDA. Alternatively, the user may use computer or PDA to read the information stored in the memory card. The above portable electronic devices are designed to be light, thin, short and small. Therefore, a user may easily misplace them and accidentally lose important information stored therein which may get into the hands of unauthorized persons.

Recently, a new method to overcome the conventional password security system, user's biological features, for example, facial outline or finger prints, are being adopted instead of password to identify the user and to provide access to the protected information. As user's biological features mentioned above are unique, and therefore such unique features cannot be imitated. Therefore, the use of biological features to protect important information or files accordingly much safer compared to the conventional method of using text password. However, the information or files may still be stolen by using special tools, or may get hacked during the transmission.

Therefore, how to overcome the above defects of the conventional art is an important issue for manufacturers in the field.

### SUMMARY OF THE INVENTION

According to an aspect of the present invention, the user's biological features are used as the password for accessing the protected data or files stored in the portable storage media. An encrypting program is adopted for encrypting/decrypting the data or files in the portable storage media to prevent any hackers from stealing the data or files.

### BRIEF DESCRIPTION OF THE DRAWING

FIG. 1 is a block diagram of a portable storage media according to an embodiment of the present invention.

FIG. 2 is a flowchart of an operation process of the portable storage media according to an embodiment of the present invention.

FIG. 3 is a block diagram of the portable storage media according to another embodiment of the present invention.

### DETAIL DESCRIPTION OF THE INVENTION

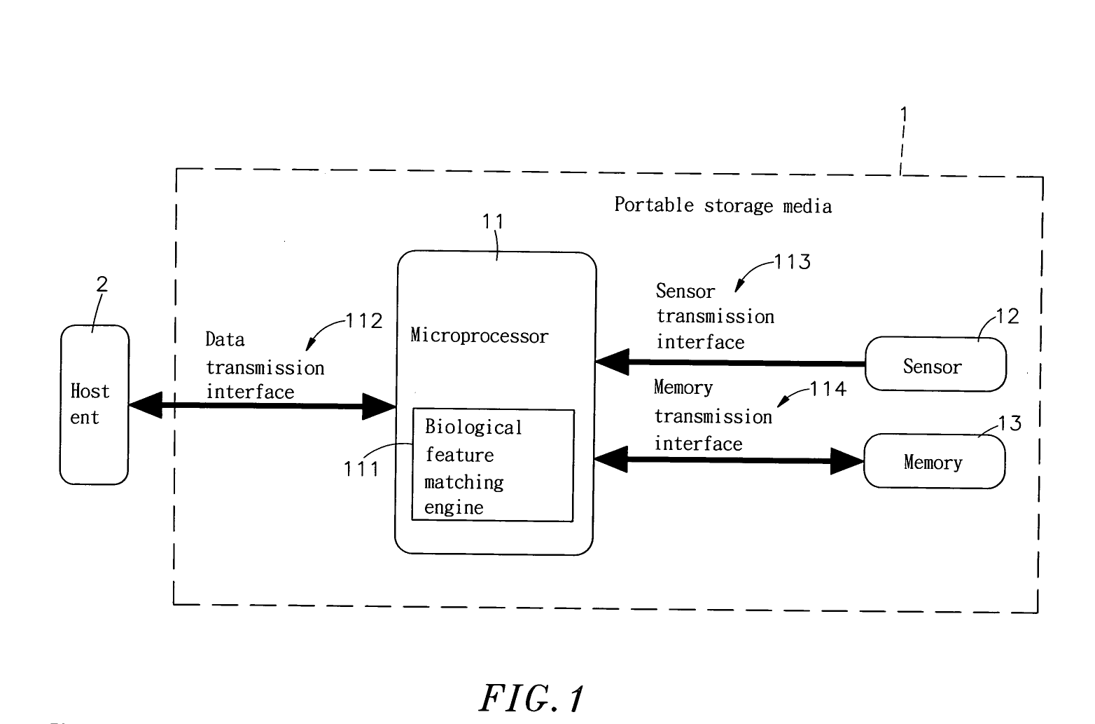

Referring to FIG. 1, a portable storage device 1 with high security function of the present invention comprises a microprocessor 11, a sensor 12 and a memory 13.

The microprocessor 11 comprises a biological feature-matching engine 111 and is connected to a data transmission interface 112, a sensor transmission interface 113 and a memory transmission interface 114.

The sensor 12 is connected to the sensor transmission interface 113 of the microprocessor 11 and is adopted for inputting the image of the user's biological feature. The biological feature may be user's fingerprint or facial outline/shape.

The memory 13 is connected to the memory transmission interface 114 of the microprocessor 11 and comprises an auto-executable encrypting program, which upon execution will be installed in a host end 2. The host end 2 may be a desktop computer, a notebook or a PDA.

When the data transmission interface 112 of the portable storage media 1 is connected to the host end 2, the host end 2 automatically executes the encrypting program in the memory 3. While a user wants to retrieve data or files stored in the portable storage media 1, the microcontroller 11 prompts the user to input a biological feature via the sensor 12. After the user inputs the unique biological feature via the sensor 12, the microcontroller 11 transmits the biological feature received by the sensor 12 to the host end 2 for the image reassembling, and then the reassembled biological image is compared with a biological feature stored in the portable storage media 1. If the reassembled biological image matches with the biological feature stored in the portable storage media 1, the host end 2 begins to process data retrieval/storage to the memory 13. When the host 2 reads the data or files from the memory 13, the encrypting program decrypts the data or files, and the decrypted data or files is transmitted by the microcontroller 11 to the host end 2. When the host end 2 writes data or files into the memory 13, the encrypting program encrypts the data or files and then transmits the encrypted data or files to the memory 13 for storage.

Furthermore, after the user inputs the unique biological feature via the sensor 12, the microcontroller 11 transmits the biological feature received by the sensor 12 to the host end 2 for the image reassembling, and the reassembled biological image is compared with the biological feature stored in the memory 3. If the reassembled biological image matches with the biological feature stored in the memory 13, the host end 2 begins to process data retrieval/storage to the memory 13. It should be noted that the host end 2 processes data retrieval/storage according to the method described above.

Thus, any unauthorized person may not be able to retrieve the protected data or files stored in the portable storage media 1 as the unauthorized person does not have the unique biological feature of the authorized user. Furthermore, even the unauthorized person steals the protected data or files by using special tools from the memory 13, because the protected data or files are being encrypted, which cannot be read without being decrypted, and therefore, the protected data or files can be effectively protected in the storage media 1. The use's biological feature may be stored in the host end 2 or the memory 13 of the portable storage media 1. The portable storage media 1 may be a portable ROM, a memory card or a hard disk.

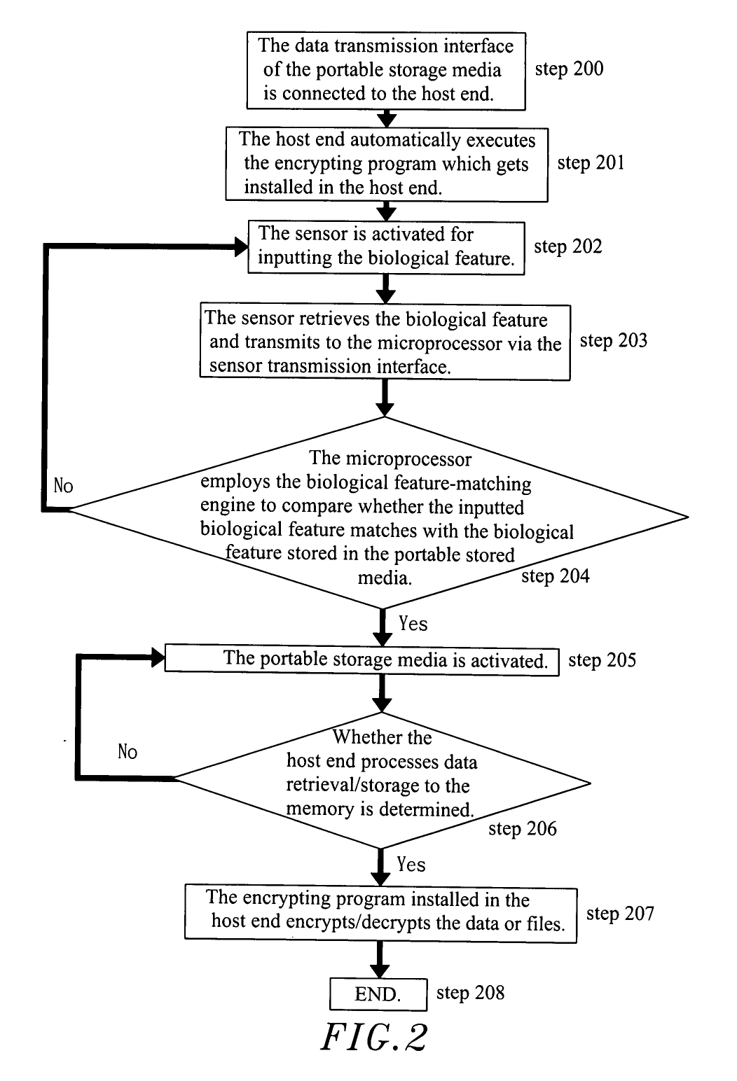

The operation procedure of the portable storage media according to an embodiment of the present invention may be described with reference to FIG. 2 as follows.

At step 200, the data transmission interface 112 of the portable storage media 1 is connected to the host end 2.

At step 201, the host end 2 automatically executes the encrypting program that gets installed in the host end 2.

At step 202, the sensor 12 is activated for inputting a biological feature.

At step 203, the sensor 12 retrieves the biological feature and transmits to the microprocessor 11 via the sensor transmission interface 113.

At step 204, the microprocessor 11 employs the biological feature-matching engine 111 to compare whether the inputted biological feature matches with the biological feature record stored in the portable stored media 1. If yes, the procedure proceeds to step 205, otherwise, the procedure returns to step 202.

At step 205, the portable storage device 1 is activated.

At step 206, whether the host end 2 processes data retrieval/storage to the memory 13 is determined; if yes, the procedure proceeds to step 207, otherwise the procedure remains at step 205.

At step 207, the encrypting program installed in the host end 2 encrypts/decrypts the data or files.

At step 208, the procedure ends.

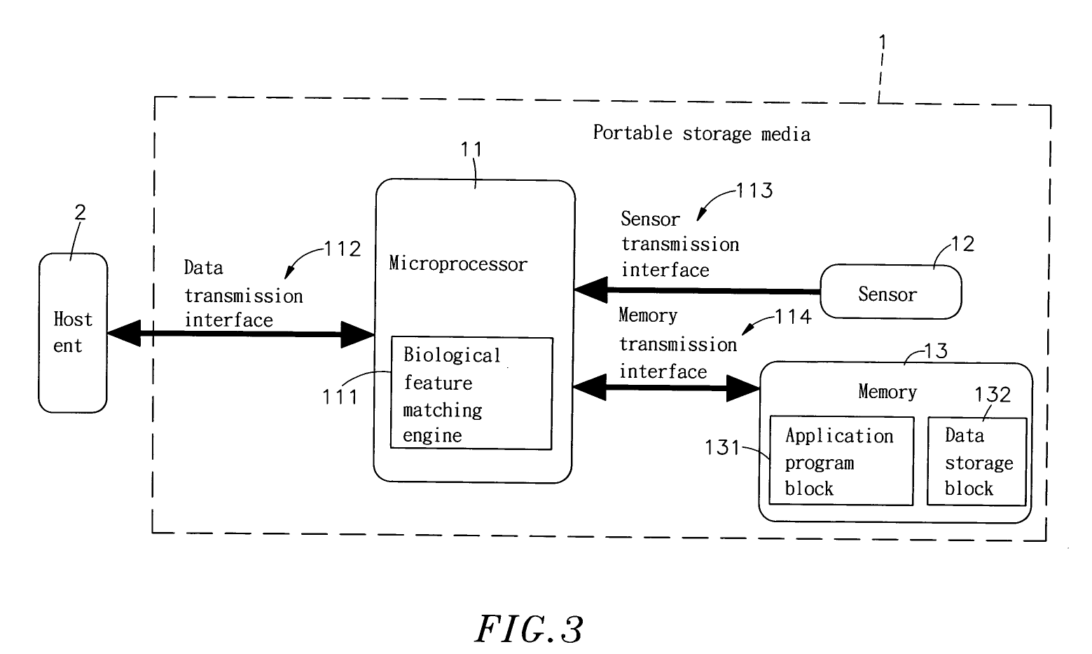

Referring to FIG. 3, the memory 13 of the portable storage media 1 comprises an application program block 131 and a data storage block 132. The application program block 131 comprises an auto-executable encrypting program in the ISO9660 format to enable the application program block 131 to perform as a ROM data type with the auto-executable function to allow the host end 2 to verify the application program block 131 as the ROM type and accordingly automatically execute the encrypting program stored in the application program block 131. Furthermore, the data storage block 132 is provided to store data and files. The data storage block 132 may be in a file allocation table (FAT) format or a NT file system (NTFS) format. The method of processing data retrieval/storage to the memory 13 upon connecting the portable storage device 1 to the host end 2 via the data transmission interface 112 is identical those described above, and therefore this description will not be repeated.

The above memory 13 may be an EROM, an EEROM, an EPROM, an EEPROM, a FLASH, an AND-FLASH, a NAND-FLASH or a NOR-FLASH. It should be noted that the above-mentioned examples of the memory 13 are merely used for illustrating the present invention, and therefore they should not be used to limit the scope of the present invention. The encrypting/decrypting method of the encrypting program may be an advanced encryption standard, a data encryption standard, a Rivest Shamir Adleman encryption or a triple data encryption algorithm. It should be noted that the above-mentioned examples of the encrypting/decrypting methods are merely used for illustrating the present invention, and therefore they should not be used to limit the scope of the present invention.

The above data transmission interface 112 may be a USB transmission interface or a SATA transmission interface, the sensor transmission interface 113 may be a parallel or serial transmission interface, and the memory transmission interface 114 may be a flash memory transmission interface or a hard disk transmission interface.

Accordingly, the portable storage media of the present invention has at least the following advantages.

1. The user is required to input a unique biological feature via the sensor 12, and the biological feature-matching engine 111 compares the inputted biological feature with the biological feature record stored in the portable storage device 1, and the user is allowed to access the protected data or files stored in the portable storage media 1 only when the inputted biological feature matches with the biological feature stored in the portable storage media 1. Thus, any unauthorized person is prevented to gain access to the protected data or files from the memory 13 of the portable storage device 1.

2. When data transmission interface 112 of the portable storage media 1 is connected to the host end 2, and the host end 2 automatically executes the encrypting program and the encrypting program is installed in the host end 2. Thus, when the host end 2 processes data or files retrieval/storage to the memory 13, the encrypting program encrypts/decrypts the data or files to protect the data or files and thereby prevent any unauthorized persons to access the protected data or files stored in the portable storage media.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A portable storage media with high security function, comprising
a microprocessor, comprising a biological feature-matching engine, connected to a data transmission interface, a sensor transmission interface and a memory transmission interface, and said data transmission interface adopted for connecting to a host end;
a sensor, connected to said sensor transmission interface of said microprocessor, adopted for inputting a biological feature; and
a memory, connected to said memory transmission interface of said microprocessor, comprising an auto-executable encrypting program that can be installed in said host end.

2. The portable storage media with high security function according to claim 1, wherein said data transmission interface comprises an USB transmission interface.

3. The portable storage media with high security function according to claim 1, wherein said data transmission interface comprises a SATA transmission interface.

4. The portable storage media with high security function according to claim 1, wherein said biological feature comprises a fingerprint.

5. The portable storage media with high security function according to claim 1, wherein said biological feature comprises a face outline/shape.

6. The portable storage media with high security function according to claim 1, wherein an encrypting method of said encrypting program comprises an advanced encryption standard.

7. The portable storage media with high security function according to claim 1, wherein an encrypting method of said encrypting program comprises a data encryption standard.

8. The portable storage media with high security function according to claim 1, wherein an encrypting method of said encrypting program comprises a Rivest Shamir Adleman encryption.

9. The portable storage media with high security function according to claim 1, wherein an encrypting method of said encrypting program comprises a triple data encryption algorithm.

10. The portable storage media with high security function according to claim 1, wherein said memory comprises an EEROM.

11. The portable storage media with high security function according to claim 1, wherein said memory comprises an EEPROM.

12. The portable storage media with high security function according to claim 1, wherein said memory comprises a flash memory.

13. The portable storage media with high security function according to claim 1, wherein said memory comprises an application program block and a data storage block.

14. The portable storage media with high security function according to claim 13, wherein said application program block comprises an encrypting program.

15. The portable storage media with high security function according to claim 13, wherein said application program block is in an ISO0660 format.

16. The portable storage media with high security function according to claim 13, wherein said data storage block is in a FAT format.

17. The portable storage media with high security function according to claim 13, wherein said data storage block is a NTFS format.

18. The portable storage media with high security function according to claim 1, wherein said storage media comprises a portable ROM.

19. The portable storage media with high security function according to claim 1, wherein said storage media comprises a memory card.

20. The portable storage media with high security function according to claim 1, wherein said storage media comprises a hard disk.
